(19) United States
(12) Patent Application Publication
(10) Pub. No.: US 2022/0027765 A1
(43) Pub. Date: Jan. 27, 2022

(54) PREDICTIVE CATEGORY CERTIFICATION

(71) Applicant: Optum, Inc., Minnetonka, MN (US)

(72) Inventors: William M. Parrish, Decatur, GA (US); Michael J. DeTolla, Bainbridge Island, WA (US); Lorri S. Sides, Hilltop Lakes, TX (US); Mark L. Morsch, San Diego, CA (US); Jason R. Robinson, La Jolla, CA (US); Mary Lisa Woods, New Castle, PA (US); Ryan A. Breisach, Edina, MN (US); Gina Marie Joyce, Flourtown, PA (US); Brian C. Potter, Carlsbad, CA (US); Anwen V. Fredriksen, Fort Collins, CO (US); Amber L. Drsata, Huntington Beach, CA (US)

(21) Appl. No.: 17/385,594

(22) Filed: Jul. 26, 2021

Related U.S. Application Data
(60) Provisional application No. 63/056,952, filed on Jul. 27, 2020.

(51) Int. Cl. G06N 5/04; G06F 16/28; G06N 20/00

(52) U.S. Cl. CPC G06N 5/04; G06N 20/00; G06F 16/285

(57) ABSTRACT

There is a need for more effectively and efficiently performing predictive data analysis to determine associations between input data objects and predictive categories This need can be addressed by, for example, solutions for performing predictive data analysis to determine associations between input data objects and predictive categories that utilize at least one of accuracy scores for predictive categories, evidentiary scores for predictive categories, and predicted certification statuses for claim data objects. In one example, a method includes: for each predictive category of one or more predictive categories associated with a claim data object, determining an accuracy score and an evidentiary score; determining a predicted certification status for the claim data object based on each accuracy score for a predictive category and each evidentiary score for a predictive category; and performing prediction-based actions based on each predicted certification status.

### CROSS-REFERENCES TO RELATED APPLICATIONS

The present application claims priority to U.S. Provisional Patent Application No. 63/056,952, filed on Jul. 27, 2020, which is incorporated by reference herein in its entirety.

### BACKGROUND

Various embodiments of the present invention address technical challenges related to performing predictive data analysis to determine associations between input data objects and predictive categories. Various embodiments of the present invention address the efficiency and reliability shortcomings of existing predictive data analysis solutions when it comes to performing predictive data analysis to determine associations between input data objects and predictive categories.

### BRIEF SUMMARY

In general, embodiments of the present invention provide methods, apparatus, systems, computing devices, computing entities, and/or the like for predictive data analysis to determine associations between input data objects and predictive categories. Certain embodiments of the present invention utilize systems, methods, and computer program products that perform predictive data analysis to determine associations between input data objects and predictive categories by using at least one of the following: accuracy scores for predictive categories, evidentiary scores for predictive categories, and predicted certification statuses for claim data objects.

In accordance with one aspect, a method is provided. In one embodiment, the method comprises: for each predictive category of one or more predictive categories that are associated with a claim data object, determining, using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category; determining a predicted certification status for the claim data object based on each accuracy score for a predictive category of the one or more predictive categories and each evidentiary score for a predictive category of the one or more predictive categories; and performing one or more prediction-based actions based on each predicted certification status for a predictive category of the one or more predictive categories.

In accordance with another aspect, a computer program product is provided. The computer program product may comprise at least one computer-readable storage medium having computer-readable program code portions stored therein, the computer-readable program code portions comprising executable portions configured to: for each predictive category of one or more predictive categories that are associated with a claim data object, determine, using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category; determine a predicted certification status for the claim data object based on each accuracy score for a predictive category of the one or more predictive categories and each evidentiary score for a predictive category of the one or more predictive categories; and perform one or more prediction-based actions based on each predicted certification status for a predictive category of the one or more predictive categories.

In accordance with yet another aspect, an apparatus comprising at least one processor and at least one memory including computer program code is provided. In one embodiment, the at least one memory and the computer program code may be configured to, with the processor, cause the apparatus to: for each predictive category of one or more predictive categories that are associated with a claim data object, determine, using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category; determine a predicted certification status for the claim data object based on each accuracy score for a predictive category of the one or more predictive categories and each evidentiary score for a predictive category of the one or more predictive categories; and perform one or more prediction-based actions based on each predicted certification status for a predictive category of the one or more predictive categories.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for predictive certification of one or more predictive categories for a claim data object in accordance with some embodiments discussed herein.

FIG. 5 provides an operational example of a prediction output user interface in accordance with some embodiments discussed herein.

FIG. 6 is a flowchart diagram of an example process for determining an evidentiary score for a claim data object with respect to a particular predictive category in accordance with some embodiments discussed herein.

FIG. 7 provides an operational example of determining evidentiary input weights for a set of evidentiary inputs in accordance with some embodiments discussed herein.

FIG. 8 provides an operational example of determining evidentiary dimension weights for a set of evidentiary dimensions in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Advantages

Various embodiments of the present invention address technical challenges related to efficiently and reliably performing certification of predictive categories (e.g., diagnostic-related groupings) for input data objects based on evaluating evidentiary data associated with the noted predictive categories. One primary challenge associated with performing certification of predictive categories for input data objects relates to the fact that predictive categories typically represent high-level data abstractions that capture a variety of complex parametric features represented by complex real-world considerations. This complexity in turn makes it challenging to efficiently and reliably map evidentiary data associated with input data objects to these complex abstractions.

In other to overcome the challenges related to efficiently and reliably performing certification of predictive categories for input data objects, various embodiments of the present invention utilize predictive data analysis techniques (e.g., machine learning techniques, such as machine learning techniques that utilize one or more trained natural language processing models) to train models that are collectively configured to capture bidirectional relationships between existing data and predictive categories. In particular, the trained machine learning models are configured to both capture how much existing data associated with an input data object supports association of a predictive category with the input data object and the strength of such supporting evidentiary data. Once trained, the machine learning models are capable to perform inference of predictive certifications for predictive categories with a lower computational complexity. They also are able to move much of the predictive data analysis processing associated with the predictive certification inference to server systems that are more likely to have more powerful capabilities for parallel and distributed processing, which in turn makes it more likely that those server systems be able to perform the predictive certification inference in a more computationally efficient, operationally reliable and stable, and speed-wise more expedient manner.

By utilizing the output of the noted trained machine learning models, various embodiments of the present invention accurately and efficiently infer predicted certification statuses for input data objects, where the noted predicted certification statuses reflect strength of associations between presumed predictive categories of the input data objects and the evidentiary data associated with the predictive categories. In doing so, various embodiments of the present invention address technical challenges related to improving efficiency and reliability of performing predictive data analysis to certify predictive categories of input data objects and make important technical contributions to the fields of machine learning and predictive data analysis. Moreover, various embodiments of the present invention improve explain-ability and/or interpretability of predictive certification operations by introducing and enabling techniques for generating explanatory data for a predictive certification, as further described below.

An exemplary application of various embodiments of the present invention relates to generating predicted certifications for diagnostic related groupings with respect to a health insurance claim data object. Various embodiments of the present invention are configured to simulate the impact of claim certification process on historical claims and associated clinical facts.

### II. Definitions

The “claim data object” may refer to a data entity that is configured to describe evidentiary data associated with a corresponding service entity, such as the evidentiary data associated with a corresponding service visit (e.g., a medical visit). In some embodiments, the claim data object describes the evidentiary data associated with a health insurance claim, where the health insurance claim may in turn be associated with one or more related medical services that are collectively associated with one or more common patients. In the noted example, examples of evidentiary data that may be described by a claim data object that is associated with a health insurance claim may include provider-generated medical charts, laboratory result data, medical imaging data, drug prescription data, and/or the like. In some embodiments, a claim data object is associated with an encoding data object, as further described below.

The term “encoding data object” may refer to a data entity that is configured to describe a collection of related predictive encodings associated with a corresponding claim data object, wherein the collection of related predictive encodings are deemed to describe prior information about an overall predictive status of the corresponding claim data object. In some embodiments, the encoding data object is processed to generate a group of claim groupings for the corresponding claim data object, where the group of claim groupings may include a collection of predictive categories that may (e.g., if certified according to various embodiments of the present invention) be used to process the claim data object. In embodiments where the claim data object describes evidentiary data associated with a health insurance claim, the encoding data object may include one or more medical service codes associated with the health insurance claim, such as diagnosis codes, pharmacy codes, medical service codes, and/or the like associated with the health insurance claim. In some of the noted embodiments, the medical service codes associated with the health insurance claim may be associated with a medical provider system that supplies the claim data object and the corresponding encoding data object for the claim data object to a health insurance provider system.

The term “claim grouping” may refer to a data entity that is configured to describe an element of a grouping scheme that describes one or more clinical conditions and/or candidate service categories for a service action as well as a hierarchical status of the association of the element to a corresponding claim data object. For example, an example grouping scheme is a medical classification system that divides candidate patient conditions treated by various service actions into a set of one or more diagnoses of a DRG, where each diagnosis describes a clinical condition or affliction, procedures codes for procedure codes associated with the service, patient demographic data for a patient entity associated with the service, patient discharge status for a patient entity associated with the service, and/or the like. A claim grouping may describe the hierarchical status of an association between such a diagnosis and a corresponding claim data object, such as the association between a diagnosis and a corresponding health insurance claim data object. For example, the claim grouping may describe that a particular diagnosis is the primary diagnosis for a corresponding claim data object. As another example, the claim grouping may describe that a particular diagnosis is a complicating condition diagnosis for a corresponding claim data object. As yet another example, the claim grouping may describe that a particular diagnosis is one of a primary diagnosis for a corresponding claim data object, a major complicating condition for the corresponding claim data object that is deemed related to the primary diagnosis for the corresponding claim data object, and a major complicating condition for the corresponding claim data object that is deemed unrelated to the primary diagnosis for the corresponding claim data object. As a further example, the claim grouping may describe that a particular diagnosis is one of a primary diagnosis for a corresponding claim data object, a major complicating condition for the corresponding claim data object, a non-major complicating condition for the corresponding claim data object that is deemed related to the primary diagnosis for the corresponding claim data object, and a non-major complicating condition for the corresponding claim data object that is deemed unrelated to the primary diagnosis for the corresponding claim data object.

The term “predictive category” may refer to a data entity that is configured to describe a category assigned to a claim data object, such as a category that is determined using one or more predictive data analysis operations, where the category may be subject to certification using one or more predictive category certification operations. In some embodiments, a predictive category is a predictive grouping that describes a claim grouping for a corresponding claim data object that is deemed to be predictively related to an optimal processing outcome (e.g., an optimal payment resolution outcome) for the corresponding claim data object, where determining whether a claim grouping is deemed to be predictively related to an optimal processing outcome is performed based on the hierarchical status for the claim grouping. For example, in some embodiments, the predictive categories associated with a corresponding claim data object describes the primary claim grouping (e.g., the primary diagnosis of a DRG) that is associated with the corresponding claim data object as well as each secondary claim grouping (e.g., each major complicating condition diagnosis) that that is deemed to be related to the corresponding primary claim grouping for the corresponding claim data object. As another example, in some embodiments, the predictive categories associated with a corresponding claim data object describe the primary claim grouping (e.g., the primary diagnosis) that is associated with the corresponding claim data object for the corresponding claim data object as well as optionally one or more secondary claim groupings (e.g., one major complicating condition diagnosis) that is deemed related to the primary claim grouping for the noted corresponding claim data object. In some embodiments, the predictive category describes an authorization determination for a claim data object. In some embodiments, the predictive category describes a recommended decision-making pathway for a claim data object. In some embodiments, the predictive category describes a recommended professional designation for a claim data object. Although various embodiments of the present invention describe generating certification predictions for predictive categories describing predictive groupings such as diagnoses or services, a person of ordinary skill in the relevant technology will recognize that the techniques described herein can be used to generate certification prediction for other types of predictive categories (e.g., other types of non-healthcare-related predictive categories).

The term “accuracy score” may refer to a data entity that is configured to describe a predicted likelihood that existing documentation for a claim data object supports a corresponding predictive category, where the corresponding predictive category is determined to be associated with the noted claim data object based on the encoding data object that is associated with the claim data object. For example, given a predictive category that describes a diagnosis for a health insurance claim data object, the accuracy score for the predictive category may describe a level of confidence that the documentation for the health insurance claim data object supports the inferred association of the primary diagnosis with the health insurance claim data object. As another example, given a predictive category that describe a major complicating condition for a health insurance claim data object, the accuracy score for the predictive category may describe a level of confidence that the documentation for the health insurance claim data object supports the inferred association of the major complicating condition with the health insurance claim data object. In some embodiments, the accuracy score may be a score in the range of [0, 1000], where a higher score conveys a higher degree of confidence that the corresponding predictive category is associated with the claim data object. In some embodiments, to determine the accuracy score for a particular predictive category, a computer system identifies a subset of the predictive encodings for the claim data object that support the particular predictive encoding, then determines a per-encoding likelihood for each predictive encoding in the identified subset that describes a predicted likelihood that the existing documentation for the claim data object supports the predictive encodings, and then combines the per-encoding likelihoods for the predictive encodings in the identified subset to determine the accuracy score for the predictive categories. For example, given a diagnosis that is determined based on two diagnosis codes and two procedures codes, the computer system may determine a first per-encoding likelihood that describes the predicted likelihood that the existing documentation supports the first diagnosis code, a second per-encoding likelihood that describes the predicted likelihood that the existing documentation supports the second diagnosis code, a third per-encoding likelihood that describes the predicted likelihood that the existing documentation supports the first procedure code, and a fourth per-encoding likelihood that describes the predicted likelihood that the existing documentation supports the second procedure code. Afterward, the computer system may combine the four per-encoding likelihoods to determine the accuracy score for the diagnosis.

The term “evidentiary score” may refer to a data entity that is configured to describe a predicted evidentiary strength of a supporting subset of the existing documentation that supports association of a corresponding predictive category with a claim data object, where the corresponding predictive category is determined to be associated with the noted claim data object based on the encoding data object that is associated with the claim data object. For example, given a predictive category that describes a diagnosis for a health insurance claim data object, the evidentiary score for the predictive category may describe a status indicator describing the level of clinical evidence that support the association of the diagnosis with the noted health insurance claim data object. As another example, given a predictive category that describes a major complicating condition for a health insurance claim data object, the evidentiary score for the predictive category may describe a status indicator describing the level of clinical evidence that support the association of the major complicating condition with the noted health insurance claim data object. In some embodiments, to determine the evidentiary score for a particular predictive category, a computer system identifies a subset of the predictive encodings for the claim data object that support the particular predictive encoding, then determines a per-encoding likelihood for each predictive encoding in the identified subset that describes a predicted evidentiary strength of a subset of the existing documentation that supports the predictive encoding, and then combines the per-encoding likelihoods for the predictive encodings in the identified subset to determine the evidentiary score for the predictive categories. For example, given a diagnosis that is determined based on two diagnosis codes and two procedures codes, the computer system may determine a first per-encoding likelihood that describes the predicted likelihood that the existing documentation supports the first diagnosis code, a second per-encoding likelihood that describes the predicted likelihood that the existing documentation supports the second diagnosis code, a third per-encoding likelihood that describes the predicted likelihood that the existing documentation supports the first procedure code, and a fourth per-encoding likelihood that describes the predicted likelihood that the existing documentation supports the second procedure code. Afterward, the computer system may combine the four per-encoding likelihoods to determine the evidentiary score for the primary diagnosis. Although various embodiments of the present invention describing generating evidentiary scores for diagnoses and/or complicating conditions, a person of ordinary skill in the relevant technology will recognize that the described techniques can be used to generate evidentiary scores for any predictive category (e.g., other claim/reimbursement types). For example, an evidentiary score may be determined for one CPT code and/or for a combination of CPT codes in relation to one another.

The term “predicted certification status” may refer to a data entity that is configured to describe a recommended processing outcome for a corresponding claim data object, where the recommended processing outcome may be determined based on at least one of the accuracy score for each predictive category with respect to the corresponding claim data object and each evidentiary score for a corresponding predictive category with respect to the corresponding claim data object. For example, the predicted certification status for a corresponding claim data object may have one of at least four values: (i) a first value describing that the claim data object should be processed as submitted, (ii) a second value describing that the claim data object should be processed with respect to the primary predictive category of the predictive categories deemed associated with the claim data object but without respect to any secondary predictive category of the predictive categories deemed associated with the claim data object, (iii) a third value describing that the claim data object should be further reviewed, and (iv) a fourth value describing that the claim data object should not be processed at all. In some embodiments, the first value discussed above is referred to herein as a complete certification status, the second value discussed above is referred to herein as a primary partial certification status, the third value discussed above is referred to herein as a review status, and the fourth value discussed above is referred to herein as a non-certification status. In some embodiments, the predicted certification status for a corresponding claim data object may be used to determine an outcome indicator having one of at least four values: (i) a first value describing that the claim data object should be processed as submitted, (ii) a second value describing that the claim data object should be processed with respect to the primary predictive category of the predictive categories deemed associated with the claim data object but without respect to any secondary predictive category of the predictive categories deemed associated with the claim data object, (iii) a third value describing that the claim data object should be further reviewed, and (iv) a fourth value describing that the claim data object should not be processed at all.

The term “bidirectional evidentiary inference machine learning model” may refer to a data entity that describes parameters and/or hyper-parameters of a machine learning model that is configured to process evidentiary data associated with a claim data object in order to generate predictive inferences about both how much the evidentiary data supports predictive categories assigned to the claim data object as well as the predictive significance of the subset of the evidentiary data that supports predictive categories assigned to the claim data object. For example, given a claim data object and a predictive category, the bidirectional evidentiary machine learning model may be configured to process the evidentiary data associated with the claim data object to generate an accuracy score for the claim data object with respect to the predictive category as well as an evidentiary score for the predictive category with respect to the claim data object. In some embodiments, the bidirectional evidentiary machine learning model may utilize one or more sub-models, such as a feature extraction sub-model that utilizes a natural language processing engine to process natural language evidentiary data (e.g., medical chart data, medical note data, and/or the like) in order to generate a feature vector for the evidentiary data, and a trained regression sub-model that may be utilized to process the feature vector to generate at least one of the accuracy score for the claim data object with respect to the predictive category as well as the evidentiary score for the predictive category with respect to the claim data object. In some of the noted embodiments, the natural language engine utilized by the feature extraction engine may utilize a bidirectional encoder transformer engine.

The term “evidentiary input” may refer to a data entity that describes that a particular evidentiary source contains data related to a corresponding predictive category for a claim data object. For example, an evidentiary input may describe that a particular section of a discharge summary document contains data related to a particular predictive category. As another example, an evidentiary input may describe that a particular section of a progress note document contains data related to a particular predictive category. In some embodiments, an evidentiary input is associated with a set of evidentiary input features, such as: an evidentiary source type that describes at least one of a document type containing the evidentiary input and a document section type containing the evidentiary input, and a length of stay correlation coefficient that describes a detected/estimated length of stay of a patient profile associated with a particular evidentiary feature in a medical facility (e.g., a hospital).

The term “evidentiary input weight” may refer to a data entity that describes an evidentiary relevance measure for a corresponding evidentiary input. For example, an evidentiary input weight may describe that a particular evidentiary input is highly relevant to certifying the association of a predictive category with a particular claim data object. As another example, an evidentiary input weight may describe that a particular evidentiary input is marginally relevant to certifying the association of a predictive category with a particular claim data object. In some embodiments, an evidentiary input weight is a value selected from a defined continuous range, e.g., the defined range of [0, 1]. In some embodiments, the evidentiary input weight for an evidentiary input is determined based on at least one of the evidentiary input features for the evidentiary input. For example, the evidentiary source type for a particular evidentiary input may be used to determine an evidentiary relevance measure for the particular evidentiary input based on a credibility measure for an evidentiary source of the particular evidentiary input (e.g., a discharge summary may be deemed to be more credible than a progress note). As another example, the length of stay correlation coefficient for a particular evidentiary input may be used to determine an evidentiary relevance measure for the particular evidentiary measure, as for example evidentiary inputs for claim data objects with high length of stay correlation coefficients may be deemed to be more credible. In some embodiments, the evidentiary input weight for an evidentiary input is determined based on at least one of where the evidentiary input originates from (e.g., from a lab value, a change in medication, intravenous diuretics data, body mass index (BMI) data, and/or the like) and/or how the evidentiary input is determined. In some embodiments, evidentiary input weights are generated during a set of training operations for the bidirectional evidentiary inference machine learning model.

The term “evidentiary dimension” may refer to a data entity that describes a grouping of evidentiary inputs that are deemed to have a common evidentiary relevance type. For example, in some embodiments, evidentiary dimensions include an affirmative evidentiary dimension that describes those evidentiary inputs that are deemed to affirm correlation of a claim data object with a predictive category, a negative evidentiary dimension that describes those evidentiary inputs that are deemed to affirm lack of correlation of a claim data object with a predictive category, and a neutral evidentiary dimension that fail to affirm either correlation of a claim data object with a predictive category or lack of correlation of the claim data object with the predictive category. As another example, in some embodiments, evidentiary dimensions include a definitive scenario evidentiary dimension that comprises those evidentiary inputs that describe the correlation between a predictive category and a claim data object is definitive, a suspect scenario evidentiary dimension that comprises those evidentiary inputs that describe the correlation between a predictive category and a claim data object is suspect, a treatment evidentiary dimension that comprises those evidentiary inputs that describe treatment of a condition associated with a predictive category via a claim data object is definitive, a counter-evidence evidentiary dimension that comprises those evidentiary inputs that describe lack of correlation between a predictive category and a claim data object, and a missing indicator evidentiary dimension that comprises those evidentiary inputs that describe absence of evidence for the correlation between a predictive category and a claim data object.

The term “evidentiary dimension value” may refer to a data entity that describes a significance of a set of evidentiary inputs for an evidentiary dimension to determining the evidentiary score for a predictive category and a claim data object. In some embodiments, the evidentiary dimension value for an evidentiary dimension is a signed value, where for example a positive-signed evidentiary dimension value may describe that a set of evidentiary inputs for an evidentiary dimension confirm correlation of a predictive category and a claim data object, and a negative-signed evidentiary dimension value may describe that a set of evidentiary inputs for an evidentiary dimension negate correlation of a predictive category and a claim data object. In some embodiments, the evidentiary dimension value for an evidentiary dimension may be determined based on at least one of: (i) an evidentiary dimension weight for the evidentiary dimension, and (ii) an evidentiary input weight combination measure that is determined based on each evidentiary input weight for an evidentiary input that is associated with the evidentiary dimension (e.g., which may be determined based on each evidentiary input weight for an evidentiary input that is associated with the evidentiary dimension, for example by summing each evidentiary input weight for an evidentiary input that is associated with the evidentiary dimension). In some embodiments, the evidentiary dimension value for an evidentiary dimension may be determined based on a product of: (i) an evidentiary dimension weight for the evidentiary dimension, and (ii) an evidentiary input weight combination measure that is determined based on each evidentiary input weight for an evidentiary input that is associated with the evidentiary dimension.

The term “evidentiary dimension weight” may refer to a data entity that describes whether and how much a set of evidentiary inputs associated with an evidentiary dimension contribute to an evidence score for a predictive category with respect to a claim data object. In some embodiments, the evidentiary dimension value for an evidentiary dimension may be determined based on a product of: (i) an evidentiary dimension weight for the evidentiary dimension, and (ii) an evidentiary input weight combination measure that is determined based on each evidentiary input weight for an evidentiary input that is associated with the evidentiary dimension. In some embodiments, the evidentiary dimension weight is a signed value, where for example a positive-signed evidentiary dimension weight may describe that a set of evidentiary inputs for an evidentiary dimension confirm correlation of a predictive category and a claim data object, and a negative-signed evidentiary dimension weight may describe that a set of evidentiary inputs for an evidentiary dimension negate correlation of a predictive category and a claim data object. In some embodiments, evidentiary dimension weights are generated during a set of training operations for the bidirectional evidentiary inference machine learning model.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises a combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

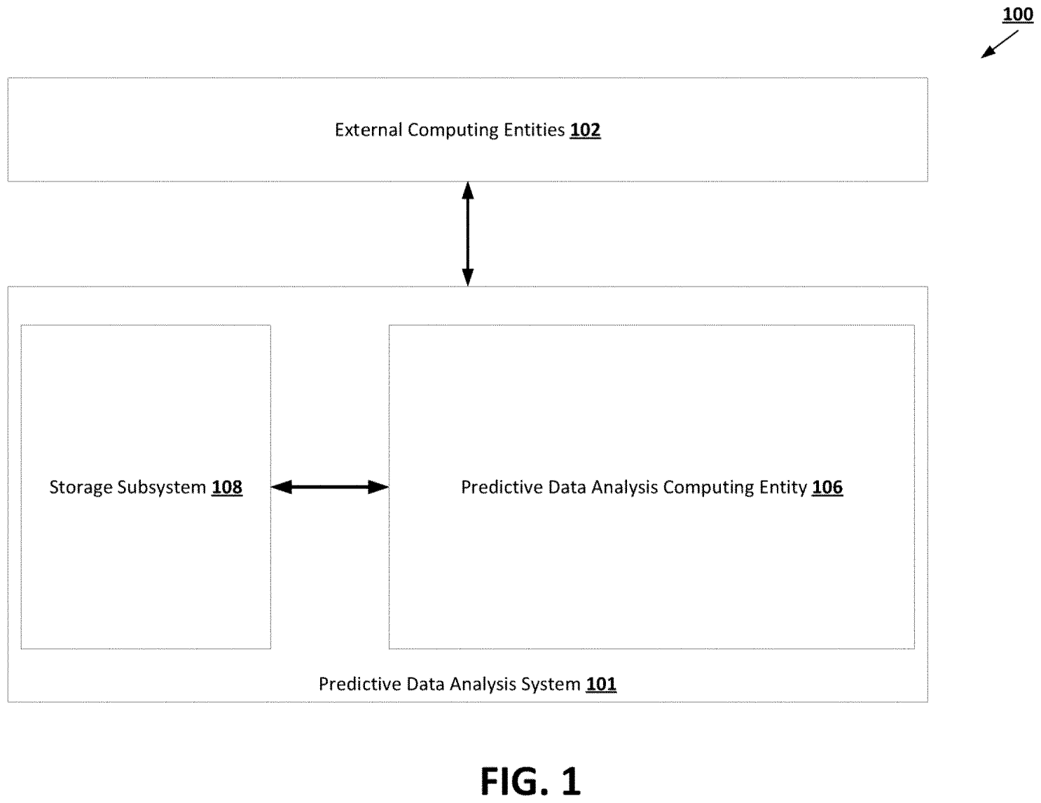

FIG. 1 is a schematic diagram of an example architecture 100 for performing predictive data analysis. The architecture 100 includes a predictive data analysis system 101 configured to receive predictive data analysis requests from external computing entities 102, process the predictive data analysis requests to generate predictions, provide the generated predictions to the external computing entities 102, and automatically perform prediction-based actions based at least in part on the generated predictions. Examples of predictive tasks that can be performing using the predictive data analysis system 101 include a predictive task determining whether to certify one or more diagnoses assigned to a health insurance claim, a predictive task determining how to certify one or more diagnoses assigned to a health insurance claim, and/or the like.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more external computing entities 102, process the predictive data analysis requests to generate predictions corresponding to the predictive data analysis requests, provide the generated predictions to the external computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

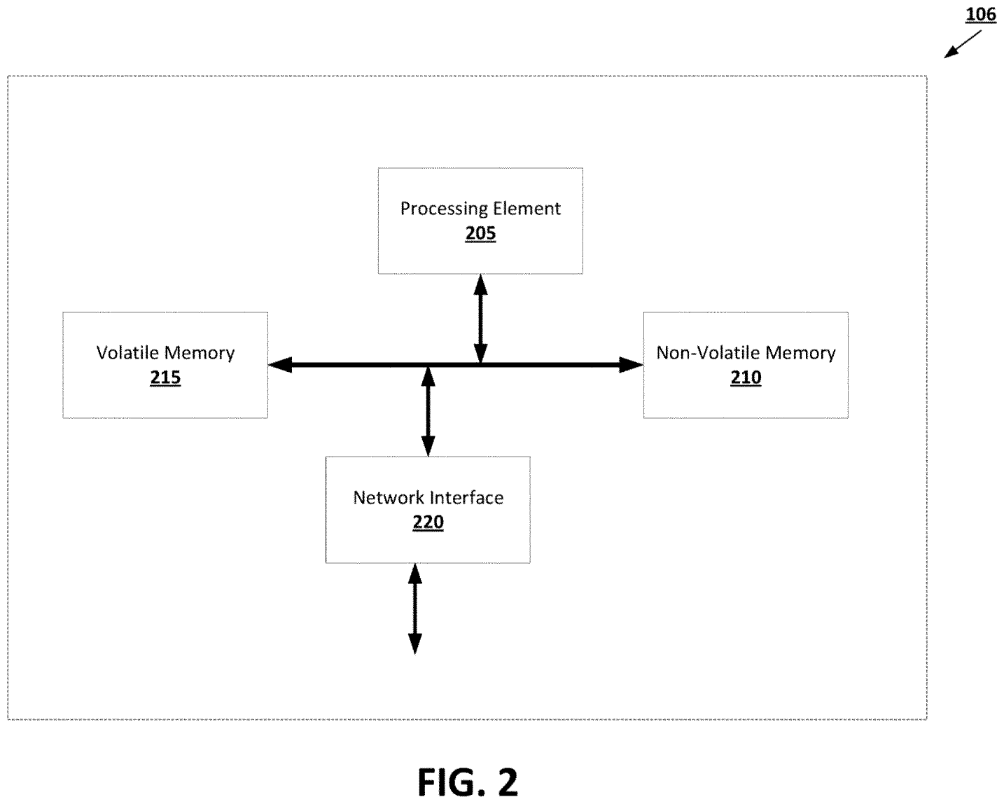

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary External Computing Entity

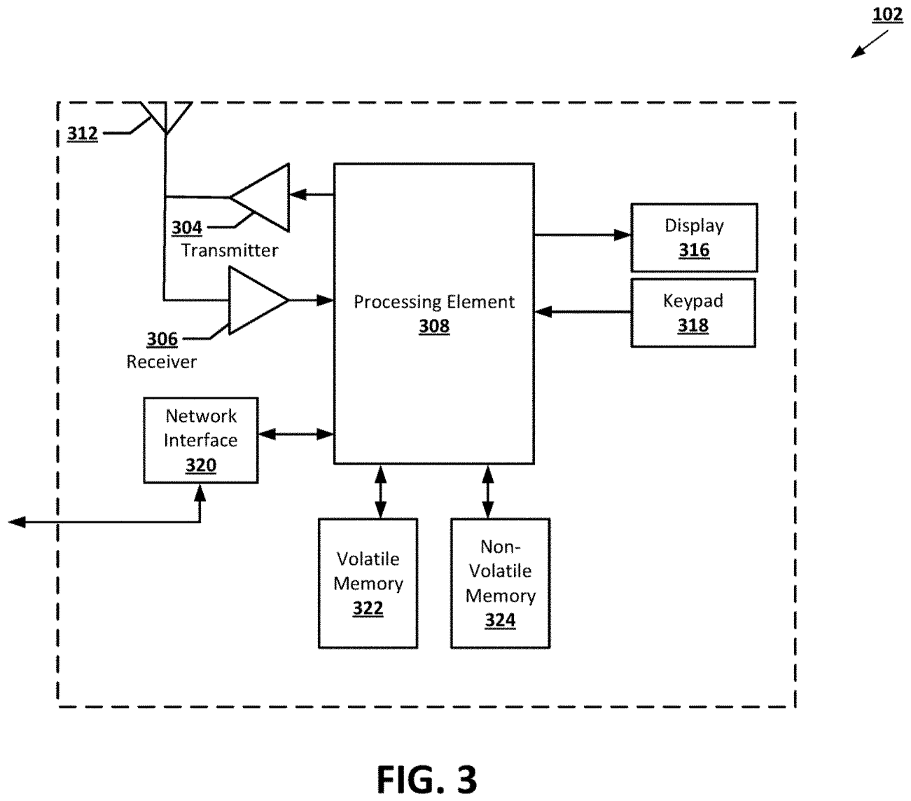

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

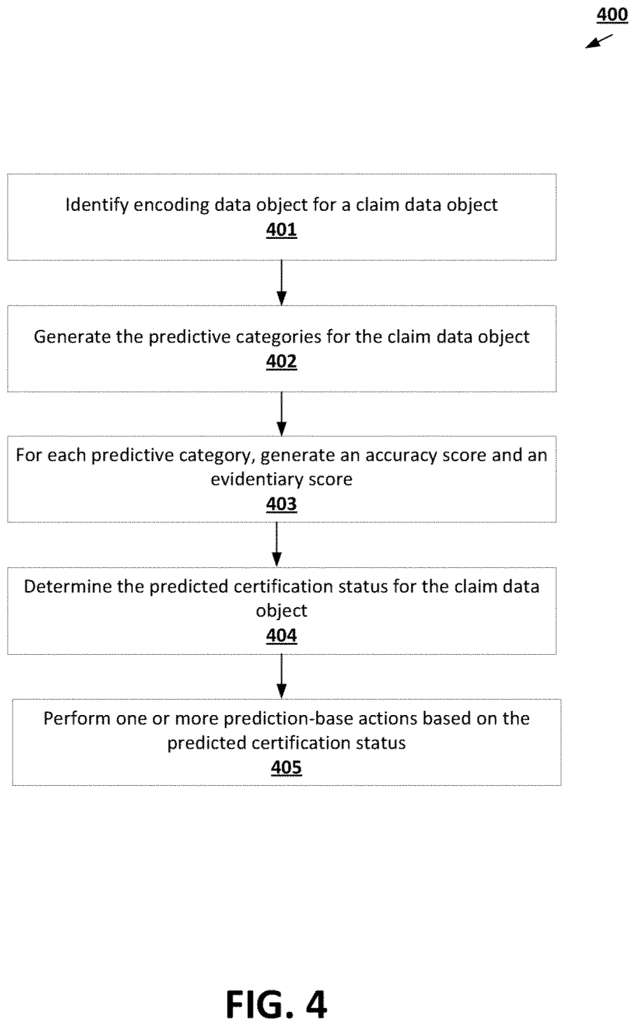

FIG. 4 is a flowchart diagram of an example process 400 for predictive certification of one or more predictive categories for a claim data object. Via the various steps/operations of the process 400, the predictive data analysis computing entity 106 can reliably and predictably perform predictive data analysis to generate a score that describes the inferred credibility of a predictive characterization of a claim data object, where the predictive characterization is in turn derived based on mapping prior predictive encodings for the claim data object to a primary predictive category and one or more secondary predictive categories. An example application of the process 400 relates to generating a score that describes an inferred credibility of a clinical condition inferred based on the evidentiary data associated with a health insurance claim, where the clinical condition is characterized by a primary diagnosis of a diagnostic-related grouping (DRG) and any related complicating conditions associated with the health insurance claim, and wherein the primary diagnosis and the related complicating conditions may be inferred based on health insurance claim codes (e.g., diagnosis codes, pharmacy codes, medical service codes, and/or the like) associated with the health insurance claim.

The process 400 begins at step/operation 401 when the predictive data analysis computing entity 106 identifies an encoding data object for the claim data object. For example, the predictive data analysis computing entity 106 may identify the claim codes associated with a health insurance claim data object.

The claim data object may describe evidentiary data associated with a corresponding service entity, such as the evidentiary data associated with a corresponding service visit (e.g., a medical visit). In some embodiments, the claim data object describes the evidentiary data associated with a health insurance claim, where the health insurance claim may in turn be associated with one or more related medical services that are collectively associated with one or more common patients. In the noted example, examples of evidentiary data that may be described by a claim data object that is associated with a health insurance claim may include provider-generated medical charts, laboratory result data, medical imaging data, drug prescription data, and/or the like. In some embodiments, a claim data object is associated with an encoding data object, as further described below.

The encoding data object may describe a collection of related predictive encodings associated with a corresponding claim data object, wherein the collection of related predictive encodings are deemed to describe prior information about an overall predictive status of the corresponding claim data object. In some embodiments, the encoding data object is processed to generate a group of claim groupings for the corresponding claim data object, where the group of claim groupings may include a collection of predictive categories that may (e.g., if certified according to various embodiments of the present invention) be used to process the claim data object. In embodiments where the claim data object describes evidentiary data associated with a health insurance claim, the encoding data object may include one or more medical service codes associated with the health insurance claim, such as diagnosis codes, pharmacy codes, medical service codes, and/or the like associated with the health insurance claim. In some of the noted embodiments, the medical service codes associated with the health insurance claim may be associated with a medical provider system that supplies the claim data object and the corresponding encoding data object for the claim data object to a health insurance provider system.

At step/operation 402, the predictive data analysis computing entity 106 generates one or more predictive categories associated with the claim data object based on the encoding data object associated with the predictive category. For example, the predictive data analysis computing entity 106 may generate a primary diagnosis and one or more complicating condition identifiers for the claim data object based on the predictive encodings described by the encoding data object.

In some embodiments, to generate the predictive categories for the claim data object, the predictive data analysis computing entity 106 first generates a group of claim groupings for the claim data object and then selects a subset of the group of claim groupings as the predictive categories for the claim data object. For example, the predictive data analysis computing entity 106 may generate a primary diagnosis for the claim data object and a group of complicating conditions for the primary diagnosis and subsequently select the collection of the primary diagnosis and at least one complicating condition that is deemed related to the primary diagnosis as the predictive categories for the claim data object.

In general, a claim grouping may describe an element of a grouping scheme that describes candidate service categories for a service action as well as a hierarchical status of the association of the element to a corresponding claim data object. For example, an example grouping scheme is a medical classification system that divides candidate patient conditions treated by various service actions into a set of diagnoses, where each diagnosis describes a clinical condition or affliction, procedures codes for procedure codes associated with the service, patient demographic data for a patient entity associated with the service, patient discharge status for a patient entity associated with the service, and/or the like. A claim grouping may describe the hierarchical status of an association between such a diagnosis and a corresponding claim data object, such as the association between a diagnosis and a corresponding health insurance claim data object. For example, the claim grouping may describe that a particular diagnosis is the primary diagnosis for a corresponding claim data object. As another example, the claim grouping may describe that a particular diagnosis is a complicating condition diagnosis for a corresponding claim data object. As yet another example, the claim grouping may describe that a particular diagnosis is one of a primary diagnosis for a corresponding claim data object, a major complicating condition for the corresponding claim data object that is deemed related to the primary diagnosis for the corresponding claim data object, and a major complicating condition for the corresponding claim data object that is deemed unrelated to the primary diagnosis for the corresponding claim data object. As a further example, the claim grouping may describe that a particular diagnosis is one of a primary diagnosis for a corresponding claim data object, a major complicating condition for the corresponding claim data object, a non-major complicating condition for the corresponding claim data object that is deemed related to the primary diagnosis for the corresponding claim data object, and a non-major complicating condition for the corresponding claim data object that is deemed unrelated to the primary diagnosis for the corresponding claim data object.

A predictive category may describe a claim grouping for a corresponding claim data object that is deemed to be predictively related to an optimal processing outcome (e.g., an optimal payment resolution outcome) for the corresponding claim data object, where determining whether a claim grouping is deemed to be predictively related to an optimal processing outcome is performed based on the hierarchical status for the claim grouping.

At step/operation 403, the predictive data analysis computing entity 106 generates an accuracy score and an evidentiary score for each predictive category in the group of predictive categories. For example, in an exemplary embodiments in which a health insurance claim data object is associated with a primary diagnosis and a major complicating condition, the predictive data analysis computing entity 106 may generate at least one of (e.g., all of) the following: (i) an accuracy score for the primary diagnosis, (ii) an evidentiary score for the primary diagnosis, (iii) an accuracy score for the major complicating condition, and (iv) an evidentiary score for the major complicating condition.

An accuracy score may describe a predicted likelihood that existing documentation for a claim data object supports a corresponding predictive category, where the corresponding predictive category is determined to be associated with the noted claim data object based on the encoding data object that is associated with the claim data object. For example, given a predictive category that describes a primary diagnosis for a health insurance claim data object, the accuracy score for the predictive category may describe a level of confidence that the documentation for the health insurance claim data object supports the inferred association of the primary diagnosis with the health insurance claim data object. As another example, given a predictive category that describe a major complicating condition for a health insurance claim data object, the accuracy score for the predictive category may describe a level of confidence that the documentation for the health insurance claim data object supports the inferred association of the major complicating condition with the health insurance claim data object. In some embodiments, the accuracy score may be a score in the range of [0, 1000], where a higher score conveys a higher degree of confidence that the corresponding predictive category is associated with the claim data object. In some embodiments, to determine the accuracy score for a particular predictive category, the predictive data analysis computing entity 106 identifies a subset of the predictive encodings for the claim data object that support the particular predictive encoding, then determines a per-encoding likelihood for each predictive encoding in the identified subset that describes a predicted likelihood that the existing documentation for the claim data object supports the predictive encodings, and then combines the per-encoding likelihoods for the predictive encodings in the identified subset to determine the accuracy score for the predictive categories. For example, given a primary diagnosis that is determined based on two diagnosis codes and two procedures codes, the predictive data analysis computing entity 106 may determine a first per-encoding likelihood that describes the predicted likelihood that the existing documentation supports the first diagnosis code, a second per-encoding likelihood that describes the predicted likelihood that the existing documentation supports the second diagnosis code, a third per-encoding likelihood that describes the predicted likelihood that the existing documentation supports the first procedure code, and a fourth per-encoding likelihood that describes the predicted likelihood that the existing documentation supports the second procedure code. Afterward, the predictive data analysis computing entity 106 may combine the four per-encoding likelihoods to determine the accuracy score for the claim data object.

An evidentiary score may describe a predicted evidentiary strength of a supporting subset of the existing documentation that supports association of a corresponding predictive category with a claim data object, where the corresponding predictive category is determined to be associated with the noted claim data object based on the encoding data object that is associated with the claim data object. For example, given a predictive category that describes a primary diagnosis for a health insurance claim data object, the evidentiary score for the predictive category may describe a status indicator describing the level of clinical evidence that support the association of the primary diagnosis with the noted health insurance claim data object. As another example, given a predictive category that describes a major complicating condition for a health insurance claim data object, the evidentiary score for the predictive category may describe a status indicator describing the level of clinical evidence that support the association of the major complicating condition with the noted health insurance claim data object. In some embodiments, to determine the evidentiary score for a particular predictive category, the predictive data analysis computing entity 106 identifies a subset of the predictive encodings for the claim data object that support the particular predictive encoding, then determines a per-encoding likelihood for each predictive encoding in the identified subset that describes a predicted evidentiary strength of a subset of the existing documentation that supports the predictive encoding, and then combines the per-encoding likelihoods for the predictive encodings in the identified subset to determine the evidentiary score for the predictive categories. For example, given a primary diagnosis that is determined based on two diagnosis codes and two procedures codes, the predictive data analysis computing entity 106 may determine a first per-encoding likelihood that describes the predicted likelihood that the existing documentation supports the first diagnosis code, a second per-encoding likelihood that describes the predicted likelihood that the existing documentation supports the second diagnosis code, a third per-encoding likelihood that describes the predicted likelihood that the existing documentation supports the first procedure code, and a fourth per-encoding likelihood that describes the predicted likelihood that the existing documentation supports the second procedure code. Afterward, the predictive data analysis computing entity 106 may combine the four per-encoding likelihoods to determine the evidentiary score for the claim data object.

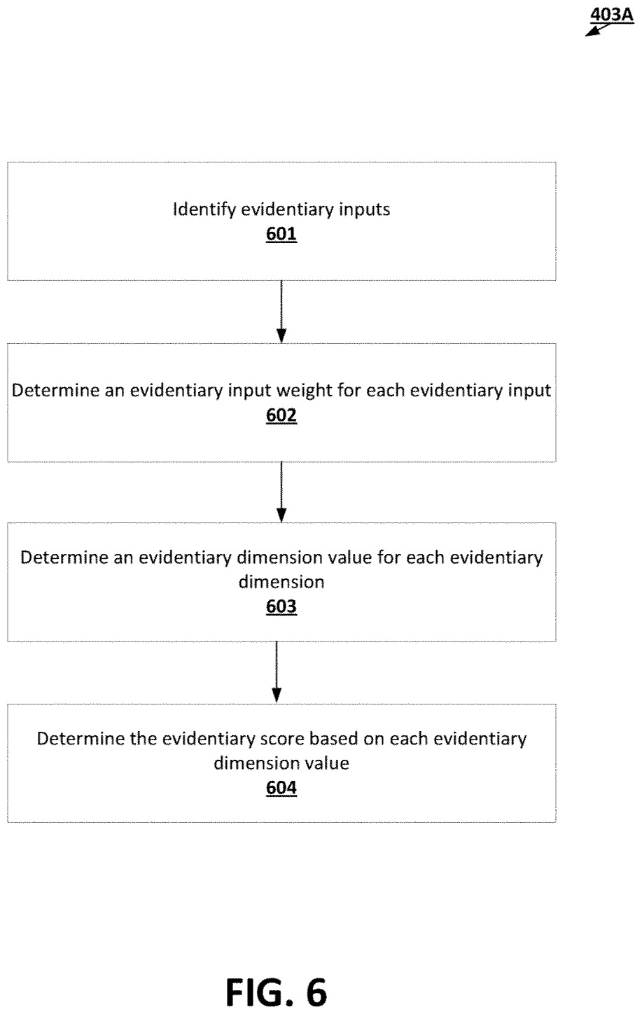

In some embodiments, step/operation 403 comprises the steps/operations of the process 403A that is depicted in FIG. 6, which is an example process for determining an evidentiary score for a claim data object with respect to a particular predictive category. The process 403A that is depicted in FIG. 6 begins at step/operation 601 when the predictive data analysis computing entity 106 identifies a plurality of evidentiary inputs associated with the particular predictive category.

In some embodiments, an evidentiary input describes that a particular evidentiary source contains data related to a corresponding predictive category for a claim data object. For example, an evidentiary input may describe that a particular section of a discharge summary document contains data related to a particular predictive category. As another example, an evidentiary input may describe that a particular section of a progress note document contains data related to a particular predictive category. In some embodiments, an evidentiary input is associated with a set of evidentiary input features, such as: an evidentiary source type that describes at least one of a document type containing the evidentiary input and a document section type containing the evidentiary input, and a length of stay correlation coefficient that describes a detected/estimated length of stay of a patient profile associated with a particular evidentiary feature in a medical facility (e.g., a hospital).

At step/operation 602, the predictive data analysis computing entity 106 determines an evidentiary input weight for each evidentiary input based on the evidentiary input features for the evidentiary input. In some embodiments, the predictive data analysis computing entity 106 processes the evidentiary input features for an evidentiary input using a trained machine learning model to generate the evidentiary input weight for the evidentiary input.

In some embodiments, an evidentiary input weight may be a value that describes an evidentiary relevance measure for a corresponding evidentiary input. For example, an evidentiary input weight may describe that a particular evidentiary input is highly relevant to certifying the association of a predictive category with a particular claim data object. As another example, an evidentiary input weight may describe that a particular evidentiary input is marginally relevant to certifying the association of a predictive category with a particular claim data object. In some embodiments, an evidentiary input weight is a value selected from a defined continuous range, e.g., the defined range of [0, 1]. In some embodiments, the evidentiary input weight for an evidentiary input is determined based on at least one of the evidentiary input features for the evidentiary input. For example, the evidentiary source type for a particular evidentiary input may be used to determine an evidentiary relevance measure for the particular evidentiary input based on a credibility measure for an evidentiary source of the particular evidentiary input (e.g., a discharge summary may be deemed to be more credible than a progress note). As another example, the length of stay correlation coefficient for a particular evidentiary input may be used to determine an evidentiary relevance measure for the particular evidentiary measure, as for example evidentiary inputs for claim data objects with high length of stay correlation coefficients may be deemed to be more credible.

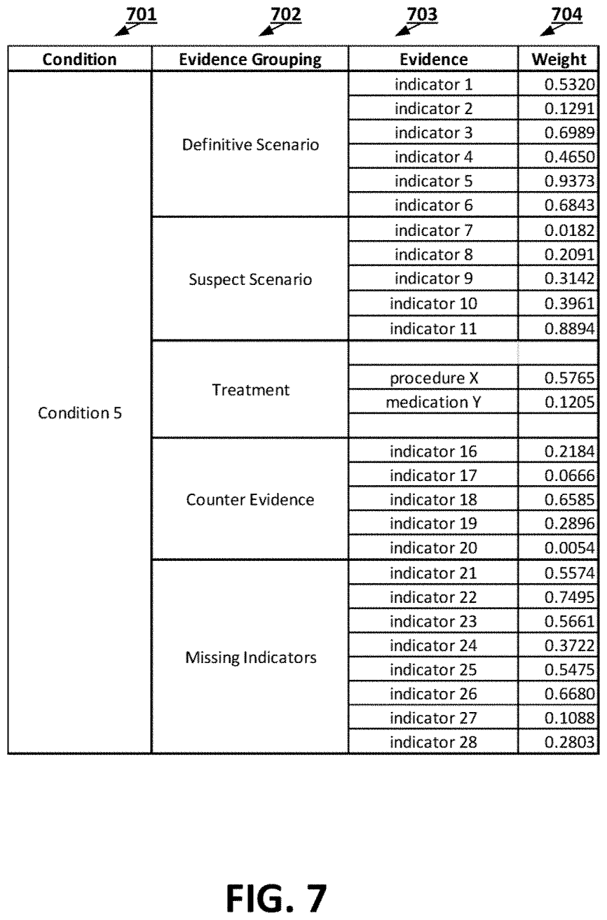

An operational example of determining evidentiary input weights is depicted in FIG. 7. As depicted in FIG. 7, each evidentiary input denoted as an indicator (which may, for example, be atomic unit of inferred evidence) in the Evidence column 703 is associated with: (i) a predictive category that is associated with a condition that is specified in the Condition column 701, (ii) an evidentiary dimension that is associated with an evidence grouping that is specified in the Evidence Grouping column 702, and (iii) a computed evidentiary input weight that is denoted using the Weight column 704. In some embodiments, user selection of each entry of the Explanation column 705 causes display of a user interface that describes at least one of the following: (i) evidence indicators that confirm certification of a predictive category (e.g., a combination of a primary diagnosis and one or more complicating conditions) that is associated with the selected entry with respect to a claim that is associated with the selected entry, (ii) evidence indicators that counter/negate certification of a predictive category that is associated with the selected entry with respect to a claim that is associated with the selected entry, (iii) any missing evidence indicators for certification of a predictive category that is associated with the selected entry with respect to a claim that is associated with the selected entry.

At step/operation 603, the predictive data analysis computing entity 106 determines an evidentiary dimension value for each evidentiary dimension based on evidentiary input weights for evidentiary inputs that are associated with the evidentiary dimension. In some embodiments, the evidentiary dimension value for an evidentiary dimension may be determined based on at least one of: (i) an evidentiary dimension weight for the evidentiary dimension, and (ii) an evidentiary input weight combination measure that is determined based on each evidentiary input weight for an evidentiary input that is associated with the evidentiary dimension.

In some embodiments, an evidentiary dimension describes a grouping of evidentiary inputs that are deemed to have a common evidentiary relevance type. For example, in some embodiments, evidentiary dimensions include an affirmative evidentiary dimension that describes those evidentiary inputs that are deemed to affirm correlation of a claim data object with a predictive category, a negative evidentiary dimension that describes those evidentiary inputs that are deemed to affirm lack of correlation of a claim data object with a predictive category, and a neutral evidentiary dimension that fail to affirm either correlation of a claim data object with a predictive category or lack of correlation of the claim data object with the predictive category. As another example, in some embodiments, evidentiary dimensions include a definitive scenario evidentiary dimension that comprises those evidentiary inputs that describe the correlation between a predictive category and a claim data object is definitive, a suspect scenario evidentiary dimension that comprises those evidentiary inputs that describe the correlation between a predictive category and a claim data object is suspect, a treatment evidentiary dimension that comprises those evidentiary inputs that describe treatment of a condition associated with a predictive category via a claim data object is definitive, a counter-evidence evidentiary dimension that comprises those evidentiary inputs that describe lack of correlation between a predictive category and a claim data object, and a missing indicator evidentiary dimension that comprises those evidentiary inputs that describe absence of evidence for the correlation between a predictive category and a claim data object.

In some embodiments, an evidentiary dimension value that describes a significance of a set of evidentiary inputs for an evidentiary dimension to determining the evidentiary score for a predictive category and a claim data object. In some embodiments, the evidentiary dimension value for an evidentiary dimension is a signed value, where for example a positive-signed evidentiary dimension value may describe that a set of evidentiary inputs for an evidentiary dimension confirm correlation of a predictive category and a claim data object, and a negative-signed evidentiary dimension value may describe that a set of evidentiary inputs for an evidentiary dimension negate correlation of a predictive category and a claim data object. In some embodiments, the evidentiary dimension value for an evidentiary dimension may be determined based on at least one of: (i) an evidentiary dimension weight for the evidentiary dimension, and (ii) an evidentiary input weight combination measure that is determined based on each evidentiary input weight for an evidentiary input that is associated with the evidentiary dimension (e.g., which may be determined based on each evidentiary input weight for an evidentiary input that is associated with the evidentiary dimension, for example by summing each evidentiary input weight for an evidentiary input that is associated with the evidentiary dimension). In some embodiments, the evidentiary dimension value for an evidentiary dimension may be determined based on a product of: (i) an evidentiary dimension weight for the evidentiary dimension, and (ii) an evidentiary input weight combination measure that is determined based on each evidentiary input weight for an evidentiary input that is associated with the evidentiary dimension.

In some embodiments, an evidentiary dimension weight describes whether and how much a set of evidentiary inputs associated with an evidentiary dimension contribute to an evidence score for a predictive category with respect to a claim data object. In some embodiments, the evidentiary dimension value for an evidentiary dimension may be determined based on a product of: (i) an evidentiary dimension weight for the evidentiary dimension, and (ii) an evidentiary input weight combination measure that is determined based on each evidentiary input weight for an evidentiary input that is associated with the evidentiary dimension. In some embodiments, the evidentiary dimension weight is a signed value, where for example a positive-signed evidentiary dimension weight may describe that a set of evidentiary inputs for an evidentiary dimension confirm correlation of a predictive category and a claim data object, and a negative-signed evidentiary dimension weight may describe that a set of evidentiary inputs for an evidentiary dimension negate correlation of a predictive category and a claim data object.

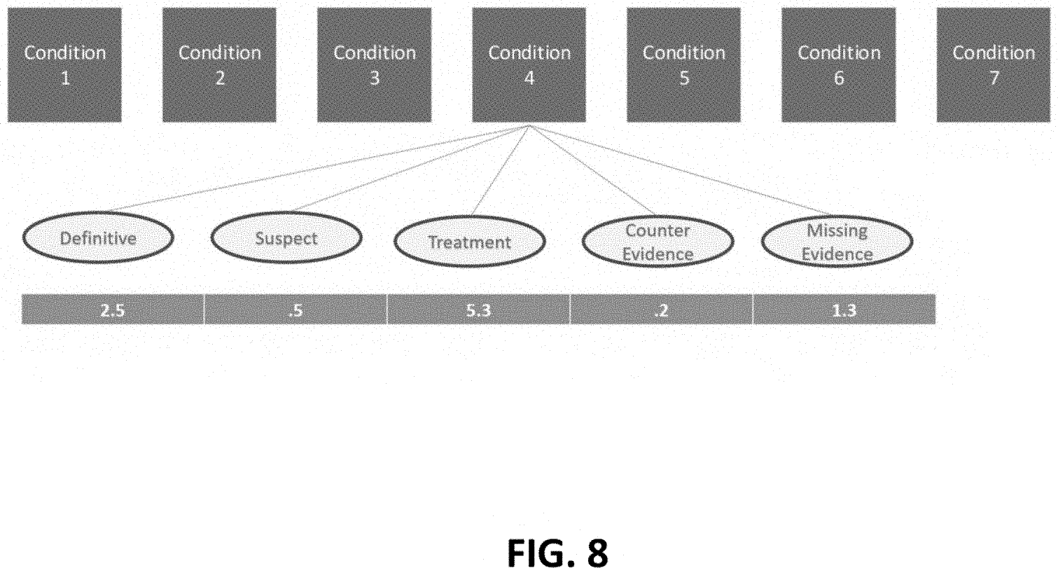

An operational example of determining evidentiary dimension values for a set of evidentiary dimensions is depicted in FIG. 8. As depicted in FIG. 8, the following evidentiary dimension values are determined for the predictive category associated with Condition 4: an evidentiary dimension value of 2.5 for a definitive scenario evidentiary dimension, an evidentiary dimension value of 0.5 for a suspect scenario evidentiary dimension, an evidentiary dimension value of 5.4 for a treatment evidentiary dimension, an evidentiary dimension value of 0.2 for a counter-evidence evidentiary dimension, and an evidentiary dimension value of 1.3 for a missing indicator evidentiary dimension.

At step/operation 604, the predictive data analysis computing entity 106 determines the evidentiary score based on each evidentiary dimension value. In some embodiments, the predictive data analysis computing entity 106 combines (e.g., sums up) each evidentiary dimension value for an evidentiary dimension to generate the evidentiary score.

As described above, an evidentiary score may describe a predicted evidentiary strength of a supporting subset of the existing documentation that supports association of a corresponding predictive category with a claim data object, where the corresponding predictive category is determined to be associated with the noted claim data object based on the encoding data object that is associated with the claim data object. For example, given a predictive category that describes a primary diagnosis for a health insurance claim data object, the evidentiary score for the predictive category may describe a status indicator describing the level of clinical evidence that support the association of the primary diagnosis with the noted health insurance claim data object. As another example, given a predictive category that describes a major complicating condition for a health insurance claim data object, the evidentiary score for the predictive category may describe a status indicator describing the level of clinical evidence that support the association of the major complicating condition with the noted health insurance claim data object.

Returning to FIG. 4, at step/operation 404, the predictive data analysis computing entity 106 determines a predicted certification status for the claim data object based on each accuracy score for a predictive category of the one or more predictive categories and each evidentiary score for a predictive category of the one or more predictive categories. For example, for each of the primary diagnosis associated with a health insurance claim data object and the major complicating condition associated with the health insurance claim data object, the predictive data analysis computing entity 106 may determine whether existing documentation adequately supports the primary diagnosis or the major complicating condition so that the health insurance claim data object may be paid with respect to the primary diagnosis or the major complicating condition, or alternatively whether for additional information is needed regarding at least one of the primary diagnosis and the major complicating condition associated with the health insurance claim data object before payment of the health insurance claim data object with respect to the at least one of the primary diagnosis and the major complicating condition. Afterward, the predictive data analysis computing entity 106 combines the noted determinations for the primary diagnosis associated with a health insurance claim data object and the major complicating condition associated with the health insurance claim data object to generate an overall conclusion.

A predicted certification status may describe a recommended processing outcome for a corresponding claim data object, where the recommended processing outcome may be determined based on at least one of the accuracy score for each predictive category with respect to the corresponding claim data object and each evidentiary score for a corresponding predictive category with respect to the corresponding claim data object. For example, the predicted certification status for a corresponding claim data object may have one of at least four values: (i) a first value describing that the claim data object should be processed as submitted, (ii) a second value describing that the claim data object should be processed with respect to the primary predictive category of the predictive categories deemed associated with the claim data object but without respect to any secondary predictive category of the predictive categories deemed associated with the claim data object, (iii) a third value describing that the claim data object should be further reviewed, and (iv) a fourth value describing that the claim data object should not be processed at all. In some embodiments, the first value discussed above is referred to herein as a complete certification status, the second value discussed above is referred to herein as a primary partial certification status, the third value discussed above is referred to herein as a review status, and the fourth value discussed above is referred to herein as a non-certification status. For example, with respect to a health insurance claim data object that is associated with a first condition as the primary diagnosis and a second condition as a major complicating condition, the complete certification status may recommend processing of the health insurance claim data object as submitted (i.e., with the first condition as the primary diagnosis and the second condition as the major complicating condition), the primary partial certification status may recommend validation prior to processing of the health insurance claim data object with the first condition as the primary diagnosis but without the second condition as the major complicating condition, the review status may recommend further validation of the health insurance claim data object, and the non-certification status may recommend validation of the health insurance claim data object.

In some embodiments, to perform step/operation 404 of the process 400, the predictive data analysis computing entity 106 utilizes a bidirectional evidentiary inference machine learning model. In some embodiments, the bidirectional evidentiary inference machine learning model be configured to process evidentiary data associated with a claim data object in order to generate predictive inferences about both how much the evidentiary data supports predictive categories assigned to the claim data object as well as the predictive significance of the subset of the evidentiary data that supports predictive categories assigned to the claim data object. For example, given a claim data object and a predictive category, the bidirectional evidentiary machine learning model may be configured to process the evidentiary data associated with the claim data object to generate an accuracy score for the claim data object with respect to the predictive category as well as an evidentiary score for the predictive category with respect to the claim data object. In some embodiments, the bidirectional evidentiary machine learning model may utilize one or more sub-models, such as a feature extraction sub-model that utilizes a natural language processing engine to process natural language evidentiary data (e.g., medical chart data, medical note data, and/or the like) in order to generate a feature vector for the evidentiary data, and a trained regression sub-model that may be utilized to process the feature vector to generate at least one of the accuracy score for the claim data object with respect to the predictive category as well as the evidentiary score for the predictive category with respect to the claim data object. In some of the noted embodiments, the natural language engine utilized by the feature extraction engine may utilize a bidirectional encoder transformer engine.

Returning to FIG. 4, at step/operation 405, the predictive data analysis computing entity 106 performs one or more prediction-based actions based on the predicted certification status for the claim data object. For example, in some embodiments, in response to determining that the predicted certification status describes a complete certification status, the predictive data analysis computing entity 106 recommends processing of the claim data object. As another example, in some embodiments, in response to determining that the predicted certification status describes a primary partial certification status, the predictive data analysis computing entity 106 recommends validation prior to processing of the claim data object. As yet another example, in response to determining that the predicted certification status describes a review status, the predictive data analysis computing entity 106 recommends further validation of the claim data object. As a further example, in response to determining that the predicted certification status describes a non-certification status, the predictive data analysis computing entity 106 recommends validation of the claim data object.

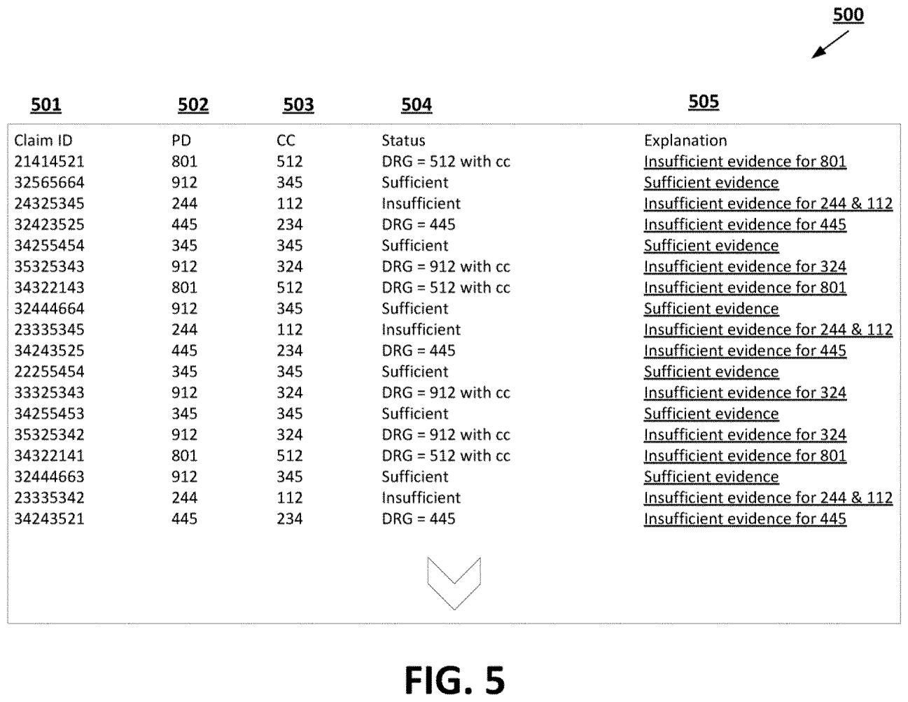

In some embodiments, to perform the prediction-based actions, the predictive data analysis computing entity 106 generates user interface data for a prediction output user interface that describes at least one of a primary grouping, one or more secondary groupings, and a predicted certification status for each claim data object of a group of claim data objects. An operational example of such a prediction output user interface 500 is depicted in FIG. 5, which describes the following information for each health insurance claim data object identified by column 501: the initial primary diagnosis for the health insurance claim data object, as described by column 502; the initial complicating condition for the health insurance claim data object, as described by column 503; a predicted certification status for the health insurance claim data object, as described by column 504; and an explanation of the predicted certification status provided in column 504, as described by column 505 in accordance with the accuracy scores and the evidentiary scores used to infer the predicted certification score.

For example, as depicted by the prediction output user interface 500 of FIG. 5 the first health insurance claim data object is associated with initial primary diagnosis 501, the complicating condition diagnosis 712, is paid with the complicating condition as the primary diagnosis and a complicating condition due to absence of evidentiary support for the initial primary diagnosis 501. In some embodiments, user interface data corresponding to prediction output user interface 500 may be transmitted to a medical provider device of a medical provider system for display on the medical provider device.

As discussed above, an example application of the process 400 relates to generating a score that describes an inferred credibility of a clinical condition inferred based on the evidentiary data associated with a health insurance claim, where the clinical condition is characterized by a primary diagnosis of a diagnostic-related grouping (DRG) and any related complicating conditions associated with the health insurance claim, and wherein the primary diagnosis and the related complicating conditions are inferred based on health insurance claim codes (e.g., diagnosis codes, pharmacy codes, medical service codes, and/or the like) associated with the health insurance claim.

In some embodiments, performing the one or more prediction-based actions includes generating explanation data for the predicted certification status based on each accuracy score and each evidentiary score; and generating user interface data for a prediction output user interface based on the explanation data, wherein the prediction output user interface is configured to be displayed to an end user of a computing entity. For example, in some embodiments, the explanation metadata may describe how each of one or more evidentiary requirements for predictive certification of a particular predictive category (e.g., certification of a primary diagnosis) are satisfied by the evidentiary data of a corresponding claim data object. In an exemplary embodiment, the predictive data analysis computing entity 106 may describe how a claim data object satisfies evidentiary requirements for a predictive certification related to a sepsis grouping.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for predictive certification of one or more predictive categories for a claim data object, the computer-implemented method comprising:
for each predictive category of the one or more predictive categories, determining, by one or more processors and using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category;
determining, by the one or more processors, a combined score determination for the claim data object based at least in part on each accuracy score for a predictive category of the one or more predictive categories and each evidentiary score for a predictive category of the one or more predictive categories.
performing, by the one or more processors, one or more prediction-based actions based at least in part on each predicted certification status for a predictive grouping of the one or more predictive groupings.

2. The computer-implemented method of claim 1, wherein:
the one or more predictive categories are selected from a plurality of claim groupings for the claim data object,
the plurality of claim groupings comprise a primary grouping and one or more secondary groupings, and
the one or more predictive categories comprise the primary grouping and a related subset of the one or more secondary groupings that relates to the primary grouping.

3. The computer-implemented method of claim 1, wherein performing the one or more prediction-based actions comprises:
in response to determining that the predicted certification status describes a complete certification status, performing a complete processing of the claim data object.

4. The computer-implemented method of claim 1, wherein performing the one or more prediction-based actions comprises:
in response to determining that the predicted certification status describes a primary partial certification status, performing a qualified processing of the claim data object in accordance with a primary grouping of the one or more predictive categories.

5. The computer-implemented method of claim 1, wherein performing the one or more prediction-based actions comprises:
in response to determining that the predicted certification status describes a non-certification status, preventing any processing of the claim data object.

6. The computer-implemented method of claim 1, wherein the one or more predictive categories are determined based at least in part on one or more predictive encodings for the claim data object.

7. The computer-implemented method of claim 1, wherein determining the evidentiary score for a particular predictive category comprises:
identifying a plurality of evidentiary inputs associated with the particular predictive category, wherein each evidentiary input is associated with one or more evidentiary input features and an evidentiary dimension of one or more evidentiary dimensions;
for each evidentiary input, determining an evidentiary input weight based on the one or more evidentiary input features;
for each evidentiary dimension, determining an evidentiary dimension value based on each evidentiary input weight for an evidentiary input that is associated with the evidentiary dimension; and
determining the evidentiary score based on each evidentiary dimension value.

8. The computer-implemented method of claim 7, wherein the one or more evidentiary input feature for an evidentiary input comprise an evidentiary source type and a length of stay correlation coefficient.

9. The computer-implemented method of claim 1, wherein the one or more evidentiary dimensions comprise a definitive scenario evidentiary dimension, a suspect scenario evidentiary dimension, a treatment evidentiary dimension, a counter-evidence evidentiary dimension, and a missing indicator evidentiary dimension.

10. The computer-implemented method of claim 1, wherein determining the evidentiary dimension value for a particular evidentiary dimension comprises:
determining an evidentiary input weight combination measure based on each evidentiary input weight for an evidentiary input that is associated with the evidentiary dimension;
identifying an evidentiary dimension weight for the particular evidentiary dimension; and
determining the evidentiary dimension value based on the evidentiary input weight combination measure and the evidentiary dimension weight.

11. The computer-implemented method of claim 1, wherein performing the one or more prediction-based actions comprises:
generating explanation data for the predicted certification status based on each accuracy score and each evidentiary score; and
generating user interface data for a prediction output user interface based on the explanation data, wherein the prediction output user interface is configured to be displayed to an end user of a computing entity.

12. An apparatus for predictive certification of one or more predictive categories for a claim data object, the apparatus comprising at least one processor and at least one memory including program code, the at least one memory and the program code configured to, with the processor, cause the apparatus to at least:
for each predictive category of the one or more predictive categories, determine, using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category;
determine a predicted certification status for the claim data object based at least in part on each accuracy score for a predictive category of the one or more predictive categories and each evidentiary score for a predictive category of the one or more predictive categories; and
perform one or more prediction-based actions based at least in part on each predicted certification status for a predictive category of the one or more predictive categories.

13. The apparatus of claim 12, wherein:
the one or more predictive categories are selected from a plurality of claim groupings for the claim data object,
the plurality of claim groupings comprise a primary grouping and one or more secondary groupings, and
the one or more predictive categories comprise the primary grouping and a related subset of the one or more secondary groupings that relates to the primary grouping.

14. The apparatus of claim 12, wherein performing the one or more prediction-based actions comprises:
in response to determining that the predicted certification status describes a complete certification status, performing a complete processing of the claim data object.

15. The apparatus of claim 12, wherein performing the one or more prediction-based actions comprises:
in response to determining that the predicted certification status describes a primary partial certification status, performing a qualified processing of the claim data object in accordance with a primary grouping of the one or more predictive categories.

16. The apparatus of claim 12, wherein performing the one or more prediction-based actions comprises:
in response to determining that the predicted certification status describes a secondary partial certification status, performing a qualified processing of the claim data object in accordance with a secondary grouping of the one or more predictive categories.

17. The apparatus of claim 12, wherein performing the one or more prediction-based actions comprises:
in response to determining that the predicted certification status describes a non-certification status, preventing any processing of the claim data object.

18. The apparatus of claim 12, wherein the one or more predictive categories are determined based at least in part on one or more predictive encodings for the claim data object.

19. A computer program product for predictive certification of one or more predictive categories for a claim data object, the computer program product comprising at least one non-transitory computer-readable storage medium having computer-readable program code portions stored therein, the computer-readable program code portions configured to:
for each predictive category of the one or more predictive categories, determine, using a bidirectional evidentiary inference machine learning model, an accuracy score and an evidentiary score, wherein: (i) the accuracy score for the predictive category describes a predicted likelihood that existing documentation for the claim data object supports the predictive category, and (ii) the evidentiary score describes a predicted evidentiary strength of a supporting subset of the existing documentation that supports the predictive category;
determine a predicted certification status for the claim data object based at least in part on each accuracy score for a predictive category of the one or more predictive categories and each evidentiary score for a predictive category of the one or more predictive categories; and
perform one or more prediction-based actions based at least in part on each predicted certification status for a predictive category of the one or more predictive categories.

20. The computer program product of claim 19, wherein:
the one or more predictive groupings are selected from a plurality of claim groupings for the claim data object,
the plurality of claim groupings comprise a primary grouping and one or more secondary groupings, and
the one or more predictive groupings comprise the primary grouping and a related subset of the one or more secondary groupings that relates to the primary grouping.
